(19) United States
(12) Patent Application Publication
(10) Pub. No.: US 2016/0113063 A1
(43) Pub. Date: Apr. 21, 2016

(54) ELECTRICAL HEATER

(71) Applicant: HEAT TRACE LIMITED, Frodsham Cheshire (GB)

(72) Inventors: Jason Daniel Harold O'Connor, Glossop, Derbyshire (GB); Peter Richard Howe, Warrington, Cheshire (GB); Ian James Scott, Hadfield, Derbyshire (GB)

(21) Appl. No.: 14/892,172

(22) PCT Filed: May 21, 2014
(86) PCT No.: PCT/GB2014/051560

§ 371 Date: Nov. 18, 2015

(30) Foreign Application Priority Data
May 21, 2013 (GB) 1309145.9
Mar. 14, 2014 (GB) 1404533.0
Mar. 14, 2014 (GB) 1404534.8

(51) Int. Cl. H05B 3/14; H01C 1/14; H01C 17/00

(52) U.S. Cl. CPC H05B 3/145; H05B 3/146; H01C 17/00; H01C 1/1406

(57) ABSTRACT

An electrical heater comprising; a first conductor, a second conductor, and a fluoropolymer heating element disposed between the first conductor and the second conductor, and a temperature regulation element disposed between the fluoropolymer heating element and the second conductor, wherein the fluoropolymer heating element comprises an electrically conductive material distributed within a fluoropolymer, and wherein the electrical heater comprises a stack, the first conductor, the second conductor, the fluoropolymer heating element, and the temperature regulation element comprising layers of the stack.

The present invention relates to an electrical heater. The electrical heater may for example be a heating mat.

Parallel resistance self-regulating heating cables are well known. Such cables normally comprise two conductors (known as buswires) extending longitudinally along the cable. Typically, the conductors are embedded within a resistive polymeric heating element, the element being extruded continuously along the length of the conductors. The cable thus has a parallel resistance form, with power being applied via the two conductors to the heating element connected in parallel across the two conductors. The heating element usually has a positive temperature coefficient of resistance. Thus as the temperature of the heating element increases, the resistance of the material electrically connected between the conductors increases, thereby reducing power output. Such heating cables, in which the power output varies according to temperature, are said to be self-regulating or self-limiting.

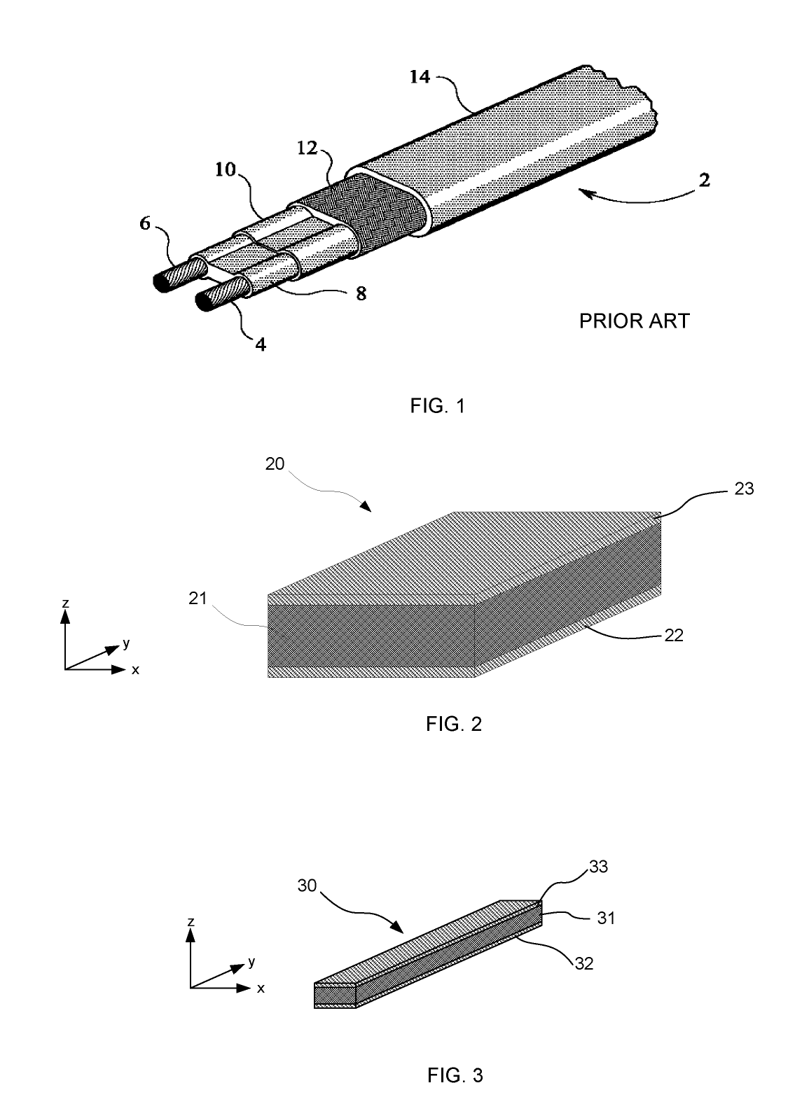

FIG. 1 illustrates a prior art parallel resistance self-regulating heating cable 2. The cable consists of a resistive polymeric heating element 8 extruded around the two parallel conductors 4, 6. A polymeric insulator jacket 10 is then extruded over the heating element 8. A conductive outer braid 12 (e.g. a tinned copper braid) is added for additional mechanical protection and/or use as an earth wire. The braid is covered by a thermo plastic overjacket 14 for additional mechanical and corrosion protection.

Such parallel resistance self-regulating heating cables possess a number of advantages over non self-regulating heating cables and are thus relatively popular. As the temperature at any particular point in the cable increases, the resistance of the heating element at that point increases, reducing the power output at that point, such that the heating cable is effectively turned down or switched off. This characteristic is known as a positive temperature coefficient of resistance (PTC). Self-regulating heating cables do not usually overheat or burn out, due to their PTC characteristics.

However, parallel resistance self-regulating heaters possess a number of undesirable characteristics.

Conventional electrical heaters are arranged to provide heat at a range of operating temperatures, depending on the application. Self-regulating electrical heaters are available which provide a self-regulation temperature of up to around 200° C. However where a higher operating temperature is required, self-regulating materials which are suitable for the formation of electrical heaters are not generally available.

It is an object of the present invention to provide an electrical heater that obviates or mitigates one or more of the problems of the prior art, whether referred to above or otherwise.

According to a first aspect of the present invention there is provided an electrical heater comprising; a first conductor, a second conductor, a fluoropolymer heating element disposed between the first conductor and the second conductor, and a temperature regulation element disposed between the fluoropolymer heating element and the second conductor; wherein the fluoropolymer heating element comprises an electrically conductive material distributed within a fluoropolymer, and wherein the electrical heater comprises a stack, the first conductor, the second conductor, the fluoropolymer heating element, and the temperature regulation element comprising layers of the stack.

The fluoropolymer heating element is referred to above as comprising an electrically conductive material distributed within a fluoropolymer. The combination of a fluoropolymer and an electrically conductive material may be referred to as a fluoropolymer compound. In the context of their use within fluoropolymer compounds, electrically conductive materials may be referred to as conductive fillers.

The term fluoropolymer heating element may be used herein instead of referring to an element comprising fluoropolymer compounds. This terminology is not, however, intended to exclude the presence of other materials within the fluoropolymer element. For instance, a fluoropolymer element may further comprise another polymer, such as high density polyethylene.

The fluoropolymer may be a perfluoroalkoxy copolymer.

The perfluoroalkoxy copolymer may be a copolymer of tetrafluoroethylene and perfluoromethyl vinyl ether or of tetrafluoroethylene and perfluoropropyl vinyl ether.

The electrically conductive material may comprise conductive particles.

The conductive particles may be selected from carbon black, graphite, graphene, carbon fibres, carbon nanotubes, metal powders, metal strand and metal coated fibres.

The fluoropolymer heating element may be arranged to operate as a second temperature regulation element.

The fluoropolymer heating element may have a positive temperature coefficient of resistance.

The temperature regulation element may comprise a second electrically conductive material distributed within an electrically insulating material.

The electrically insulating material may comprise a polymer.

The second electrically conductive material may comprise conductive particles.

The conductive particles may be selected from carbon black, carbon fibres, carbon nanotubes or metal powders.

The thickness of the temperature regulation element may be substantially constant throughout the electrical heater.

The electrical heater may further comprise a third conductor, the third conductor being disposed between the fluoropolymer heating element and the temperature regulation element.

The third conductor may be formed from metal foil.

The thickness of the fluoropolymer heating element may be substantially constant throughout the electrical heater.

Each layer of the stack may lie substantially parallel to a plane.

The electrical heater may extend in a first direction parallel to the plane to a significantly lesser extent than in a second direction parallel to the plane, the first direction being perpendicular to the second direction.

The first conductor and the second conductor may be formed from metal foils.

The first conductor and/or the second conductor may have a cross sectional area in a plane normal to the second direction of at least 10 mm².

According to a second aspect of the present invention there is provided a method of manufacturing an electrical heater, the electrical heater comprising a first conductor, a fluoropolymer compound, and a second conductor arranged in a stack, the fluoropolymer compound comprising an electrically conductive material distributed within a fluoropolymer and being disposed between the first conductor and the second conductor, wherein the first conductor is in direct contact with the fluoropolymer compound, the method comprising: raising the temperature of the fluoropolymer compound so as to melt the fluoropolymer compound; applying force to the first conductor and the fluoropolymer compound so as to force substantially all of the air from between the first conductor and the fluoropolymer compound and from within the fluoropolymer compound; and cooling the fluoropolymer compound to ambient temperature such that, when cooled, the fluoropolymer compound is arranged to form a fluoropolymer heating element and is bonded to the first conductor; wherein the method is a continuous process.

The method may further comprise: providing a temperature regulation compound, the temperature regulation compound comprising a second electrically conductive material distributed within an electrically insulating material, wherein the temperature regulation compound is disposed between the second conductor and the fluoropolymer heating element, and the fluoropolymer heating element is disposed between the temperature regulation compound and the first conductor, raising the temperature of the temperature regulation compound so as to melt the temperature regulation compound; applying force to the first conductor, the second conductor, the fluoropolymer heating element and the temperature regulation compound so as to force substantially all of the air from between the first conductor, the second conductor, the fluoropolymer heating element and the temperature regulation compound, and from within the temperature regulation compound; and cooling the temperature regulation compound to a temperature below the melting point of the temperature regulation compound such that, when cooled, the temperature regulation compound is arranged to form a temperature regulation element.

The method may further comprise providing a third conductor during the steps of: raising the temperature of the fluoropolymer compound so as to melt the fluoropolymer compound; and applying force to the first conductor and the fluoropolymer compound so as to force substantially all of the air from between the first conductor and the fluoropolymer compound, and from within the fluoropolymer compound; such that the fluoropolymer heating element is disposed between the first conductor and the third conductor.

According to a third aspect of the present invention there is provided a method of manufacturing an electrical heater, the electrical heater comprising a first conductor, a fluoropolymer compound, and a second conductor arranged in a stack, the fluoropolymer compound comprising an electrically conductive material distributed within a fluoropolymer and being disposed between the first conductor and the second conductor, wherein the first conductor is in direct contact with the fluoropolymer compound, the method comprising: raising the temperature of the fluoropolymer compound so as to melt the fluoropolymer compound; applying force to the first conductor, the second conductor and the fluoropolymer compound so as to force substantially all of the air from between the first conductor and the fluoropolymer compound, and from between the second conductor and the fluoropolymer compound; and cooling the fluoropolymer compound to ambient temperature such that, when cooled, the fluoropolymer compound is arranged to form a fluoropolymer heating element and is bonded to the first conductor and the second conductor; wherein the method is a continuous process.

Force may be at least partially applied by extrusion through a die.

Force may be at least partially applied by rollers.

Applying force to the first conductor and the fluoropolymer compound may comprise: applying a first force to the fluoropolymer compound so as to force substantially all of the air from within the fluoropolymer compound; and applying a second force to the first conductor and the fluoropolymer compound so as to force substantially all of the air from between the first conductor and the fluoropolymer compound.

The first force may be applied by extrusion through a die.

The second first force may be applied by passing the first conductor and the fluoropolymer compound through rollers.

The fluoropolymer may be a copolymer of tetrafluoroethylene and perfluoro methyl vinyl ether or of tetrafluoroethylene and perfluoropropyl vinyl ether.

The electrically conductive material may comprise at least one of carbon black, graphite, graphene, carbon fibres, carbon nanotubes, metal powders, metal strand and metal coated fibres.

According to a fourth aspect of the present invention there is provided an electrical heater comprising: a first conductor which extends along a length of the electrical heater, a fluoropolymer heating element disposed around the first conductor and along the length of the electrical heater; and a second conductor disposed around the fluoropolymer heating element and along the length of the electrical heater; wherein the fluoropolymer heating element comprises an electrically conductive material distributed within a fluoropolymer.

The first conductor and/or the second conductor may have a cross sectional area in a plane normal to the length of the electrical heater of at least 10 mm². The cross sectional area of the first and/or second conductor is preferably at least 20 mm². The cross sectional area of the first and/or second conductor is more preferably approximately 40 mm².

The fluoropolymer may be a perfluoroalkoxy copolymer.

The perfluoroalkoxy copolymer may be a copolymer of tetrafluoroethylene and perfluoromethyl vinyl ether or of tetrafluoroethylene and perfluoropropyl vinyl ether.

It will be appreciated that where features are discussed in the context of one aspect of the invention they may be applied to other aspects of the invention.

Embodiments of the present invention will now be described, by way of example, with reference to the accompanying drawings, in which:

FIG. 1 is a partially cut away perspective view of a prior art parallel resistance self-regulating heating cable;

FIG. 2 is a perspective view of an electrical heater in accordance with an embodiment of the present invention;

FIG. 3 is a perspective view of an electrical heater in accordance with an alternative embodiment of the present invention;

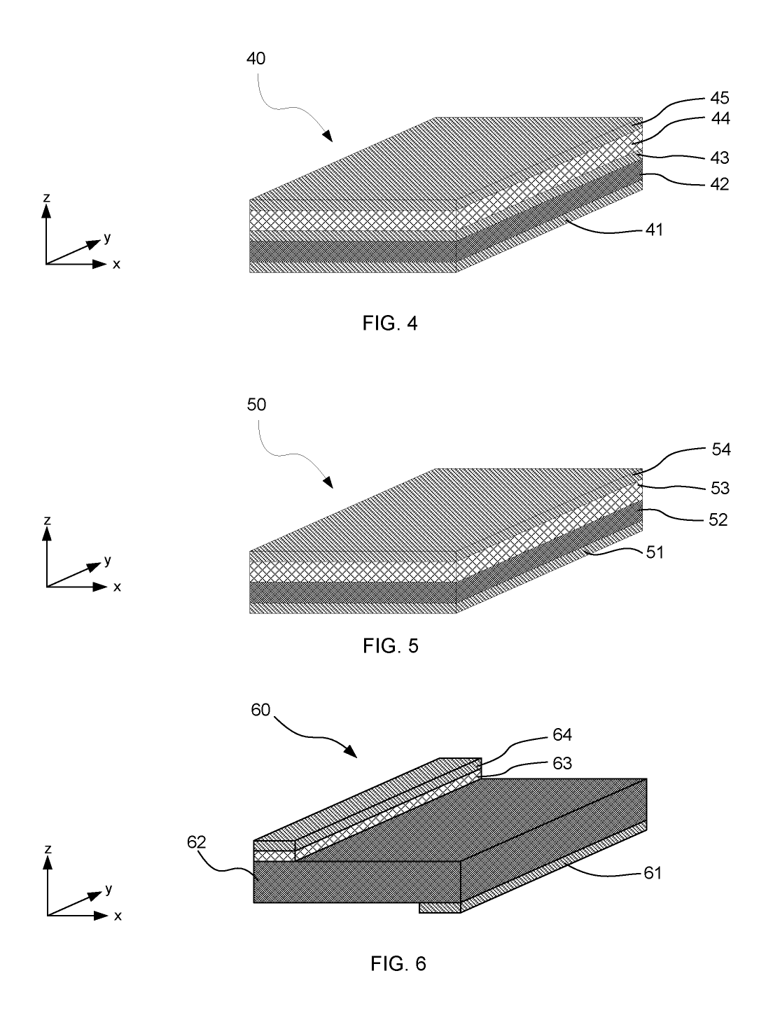

FIG. 4 is a perspective view of an electrical heater in accordance with an alternative embodiment of the present invention;

FIG. 5 is a perspective view of an electrical heater in accordance with an alternative embodiment of the present invention;

FIG. 6 is a perspective view of an electrical heater in accordance with an alternative embodiment of the present invention; and

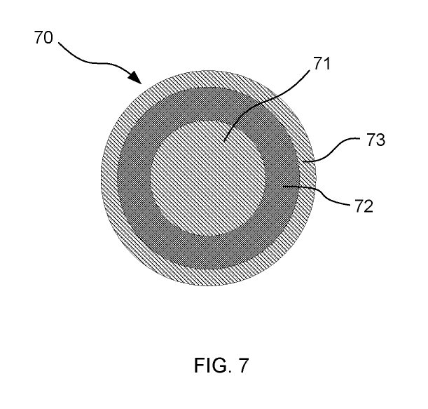

FIG. 7 is an end-on view of an electrical heater in accordance with an alternative embodiment of the present invention.

FIG. 2 illustrates schematically a self-regulating electrical heater 20 in accordance with an embodiment of the present invention. The electrical heater 20 may be a heating mat. The electrical heater 20 comprises a stack of elements. A fluoropolymer heating element 21 extends throughout the centre of the electrical heater 20. The fluoropolymer heating element 21 is sheet-like in form, having a substantially uniform thickness. The fluoropolymer heating element 21 extends in a first dimension x and a second dimension y to a significantly greater extent than the thickness, which is in the third dimension z. The fluoropolymer heating element 21 has a positive temperature coefficient, such that resistance of the fluoropolymer heating element 21 increases with temperature.

The fluoropolymer heating element 21 comprises a conductive filler distributed within a matrix of an insulative material. The insulative material is a fluoropolymer. The fluoropolymer may, for example, be a perfluoroalkoxy polymer. The perfluoroalkoxy polymer may be a copolymer of tetrafluoroethylene and perfluoropropyl vinyl ether (PFA). Alternatively the perfluoroalkoxy polymer may be a copolymer of tetrafluoroethylene and perfluoromethyl vinyl ether (MFA). In a further alternative, the perfluoroalkoxy polymer may be a copolymer of tetrafluoroethylene and perfluoroethyl vinyl ether (EFA).

The conductive filler may be conductive particles. The conductive particles may be particles of carbon black. The combination of a fluoropolymer and conductive fillers may be referred to as a fluoropolymer compound. An element within an electrical heater which comprises a fluoropolymer compound may be referred to as a fluoropolymer element.

The fluoropolymer heating element 21 may be formed from a number of other suitable materials. Table 1 lists example ranges and example materials which may be suitable for use to form the fluoropolymer heating element 21. Any one or more of the listed materials could be utilised, from any one or more of the listed types.

TABLE 1
Fluoropolymer Element: Range of Formulations

| | | Addition |
|---|---|---|
| Type | Compounds could include but not be limited to | Range |
| Conductive | Carbon Black | 2%-45% |
| | Graphite | |
| | Graphene | |
| | Carbon fibre | |
| | Carbon Nanotubes | |
| | Metal Powders | |
| | Metal strand | |
| | Metal coated fibre | |
| Insulative | Fluoropolymers: | 55%-98% |
| | PFA: Copolymer of Tetrafluoroethylene | |
| | and Perfluoropropyl vinyl ether | |
| | EFA: Copolymer of Tetrafluoroethylene | |
| | and Perfluoroethyl vinyl ether | |
| | MFA: Copolymer of Tetrafluoroethylene | |
| | and Perfluoroethyl vinyl ether | |

The fluoropolymer heating element 21 is sandwiched between a first conductor 22 and a second conductor 23. The fluoropolymer heating element 21, the first conductor 22 and the second conductor 23 may be considered to form a stack. The first and second conductors 22, 23 are formed of a metal foil. The metal foil may be made from any suitable metal, such as, for example, aluminium. Another example of a metal which may be suitable for use as a metal foil is copper. The first and second conductors 22, 23 are fixed to opposite sides of the fluoropolymer heating element 21.

The term “metal foil” is intended to mean any sheet-like form of metal. However, it will be appreciated that while a foil is usually continuous, it may also be discontinuous. For example, a foil may comprise a sheet of metal containing a plurality of apertures. A metal foil may have a thickness of, for example, around 0.15 mm. A metal foil may, for example, have a thickness of up to around 0.5 mm.

The electrical heater 20 may have self-regulating characteristics by virtue of the positive temperature coefficient of resistance (PTC) characteristic of the fluoropolymer heating element 21. At normal operational temperatures (i.e. below the self-regulating temperature of the electrical heater 20) the fluoropolymer heating element 21 will have an electrical resistance which is determined by the resistivity of the fluoropolymer heating element 21 and the geometry of the electrical heater 20. A voltage applied between the first and second conductors 22, 23 will cause current to flow through the fluoropolymer heating element 21. The fluoropolymer heating element 21 will deliver heat by converting electrical energy supplied as current through the conductors 22, 23 to thermal energy, through resistive heating. However, as the temperature increases, the resistance of the fluoropolymer heating element 21 will rise. The increase in resistance may have an approximately linear relationship with the increase in temperature. The increased resistance between the conductors 22, 23 causes the current flowing through the electrical heater 20 to be reduced, reducing the amount of thermal energy produced by the fluoropolymer heating element 21. The reduced amount of thermal energy produced by the fluoropolymer heating element limits the further rise of the temperature of the electrical heater 20. Eventually a temperature is reached at which the resistance is sufficiently high to prevent further heating. This temperature is referred to as the self-regulation temperature.

Electrical heaters having a fluoropolymer heating element which self-regulates in this way may allow a self-regulation temperature of above 150° C. to be achieved. A self-regulation temperature of up to 300° C. may be achieved. Conventional heating cables having a heating element which comprises an HDPE compound heating element which also has self-regulating behaviour typically self-regulate at around 100° C. or below.

A failure mode of prior art parallel resistance self-regulating heating cables is loss of, or reduction in, electrical contact between the power conductors and the extruded resistive matrix forming the heating element. For example, differential expansion of the components and thermal cycling may lead to such failure or reduction in electrical contact over time. This problem is exacerbated by the materials which are commonly used. High Density Polyethylene (HDPE) is frequently used as a matrix for the resistive heating part, while copper is commonly used to form the conductors.

However, it has been found that HDPE does not adhere well to the copper conductors, leading to a high likelihood of the electrical contact being reduced. Such a reduction in electrical contact may lead to electrical arcing within the cable, and a consequent loss in thermal output. The operational life of the product may thus be dependent upon the bond between the conductors and the heating element.

Furthermore, when designing electrical heaters suitable for delivering heat at temperatures above the melting point of HPDE based materials, alternative materials must be sought. While fluoropolymers are known to have higher melting points, they are generally used for non-stick applications due to the reluctance fluoropolymers exhibit for bonding with other materials. For this reason, fluoropolymers would not conventionally be considered for use in electrical heaters, where good adhesion to conductors and other heater components is essential for continued operation. Good adhesion is especially important considering the known problems associated with prior art parallel resistance self-regulating heating cables, as described above.

The inventors have surprisingly realised that fluoropolymers, which are widely regarded as ‘non-stick’ materials, can be bonded to metal conductors to form an electrical heater.

The use of a fluoropolymer element between the conductors as a heating element provides an advantage over prior art heaters. The fluoropolymer element forms strong bonds with the conductors (e.g. aluminium or copper), ensuring that a good electrical and mechanical contact is maintained between the heating element and the conductors, thereby prolonging the life-time of the electrical heater. The fluoropolymer element may also act to regulate the temperature within the electrical heater, providing an increased self-regulating temperature when compared to prior art heaters formed from HDPE compounds.

The use of a fluoropolymer heating element may provide a further advantage when compared to prior art electrical heaters in that it provides a higher power density than is provided in prior art heaters formed from HDPE compounds.

A process by which electrical heaters according to the embodiment of the invention shown in FIG. 2 may be formed will now be described. The electrical heater 20 is formed using a press, which is arranged to apply variable force to a workpiece, while also maintaining the workpiece at a controlled temperature. The controlled temperature may be an elevated temperature. The material for forming the work-piece is loaded into the press within a mould. The mould comprises a void of a predetermined volume, with dimensions which define the shape of the finished work-piece. The mould further comprises plates which define the upper and lower boundaries of the void, and which make contact with the work-piece during the pressing procedure. The void of the mould is sized appropriately depending on the intended final dimensions of the electrical heater 20.

A sheet of metal foil is placed on the bottom plate of a press. The metal foil will form the first conductor 22.

A mould plate designed for the purpose of creating the fluoropolymer heating element 21 is then placed on the bottom plate of the press, above the metal foil. A known quantity of pre-mixed material for forming the fluoropolymer heating element 21 is then placed into the heating element mould. The pre-mixed material may be in the form of pellets. The pre-mixed material is a PFA based self-regulating compound, which comprises PFA blended with a conductive filler such as particles of carbon black. The PFA based self-regulating compound will be referred to as the PFA compound.

A second sheet of metal foil is then placed above the mould plate. This second sheet of metal foil will form the second conductor 23. The top plate of the press is then placed above the second sheet of metal foil.

The stack of plates, including the heater components, is then inserted into the press. An initial force is then applied to the mould, and maintained as the press is heated to a temperature above the melting temperature of the PFA compound. PFA has a melting point of around 300° C. However, it will be appreciated that the melting point of the PFA compound may differ from that of the pure material. The temperature of the press is kept below the thermal degradation temperature of PFA. The thermal degradation temperature of PFA may be around or in excess of 450° C. A temperature of between 310° C. and 360° C. may be selected as a target temperature to melt the PFA compound (i.e. a temperature above the melting point and below the thermal degradation temperature of the materials used). Appropriate processing temperatures for a particular material or material blend can be determined from the melting point and degradation temperatures of that material or material blend.

The application of the initial force ensures that the pellets of PFA compound are evenly distributed within the press. The initial force should be sufficient to ensure that the PFA compound is in good contact with both the bottom and top plates of the press, rather than just the bottom plate. This allows the PFA compound to be melted by both the top and bottom plates. A force of 20 kN is suitable as the initial force when applied to a mould containing PFA compound having dimensions of 100 mm×200 mm. Once the target temperature has been reached, the initial force is maintained for a period sufficient to ensure that all of the PFA compound is melted. A period of 10 minutes is sufficient to allow the PFA compound to have fully melted.

The above mentioned values of force, temperature, and period of time of the initial pressing process are selected to cause the PFA compound to melt. Any parameter may be adjusted provided that the stated aim, of causing the PFA compound to melt, is achieved. For example, while evenly melting the PFA material from both bottom and top plates may be desirable, it is not essential. The application of pressure may be omitted, with the period for which the PFA material is held at a raised temperature being increased accordingly.

The application of any force will depend upon the area over which the force is applied. The pressure applied to the PFA material should be selected to achieve the intended outcome. The force is then calculated based on the area of the PFA compound mould and the pressure which is to be applied.

Once the initial pressing has caused the PFA compound to melt, the force applied by the press is increased to a higher force, exerting a higher pressure on the PFA compound, causing air to be expelled from the PFA compound. The higher force is applied for a period of time, while the temperature is maintained at a level sufficient to keep the PFA compound in molten form. The higher force and time period for which it is applied are chosen to ensure that substantially all air has been expelled from the PFA compound. A force of 200 kN is suitable when applied to a PFA compound mould with dimensions of 100 mm×200 mm. A period of 10 minutes is sufficient to cause substantially all of the air within the PFA compound to be expelled, when combined with a force of 200 kN.

The period for which the force and high temperature are maintained should also be sufficient for the formation of a bond between the metal foils and the PFA compound (the 10 minute period referred to above is sufficient). The formation of the bond between the metal foil and the PFA compound may be understood by reference to the surface properties of the PFA compound. The application of heat and pressure create conditions in which the surface tension of the PFA compound is sufficiently low, and the PFA compound sufficiently soft, that the PFA compound wets the metal surface. When the heat and pressure are removed, the PFA compound is sufficiently hard that it is able to resist forces applied to the bond which act to separate the materials. The strength of the bond is also understood to be enhanced by hydrogen-bonding and van der Waals interactions.

The press is then rapidly cooled to a temperature below the melting point of the PFA compound. Cooling may be brought about by any convenient mechanism. For example, cooling water channels within the press plates can be provided with chilled water from a water chiller. Depending on the temperature of the plates, as water is provided to the cooling water channels it may be heated rapidly, causing the water to boil, generating steam. The rapid expansion of steam may be accommodated in such a system by an appropriately sized and reinforced expansion tank. The heat carried away from the press plates by the water causes the temperature of the plates, and also the pressed PFA compound to be reduced. Chilled water may be provided to the press plates continuously, until a satisfactory press temperature is reached.

The temperature is brought below the melting point of the PFA compound. The temperature is also brought below any temperature at which any significant deformation or crystallisation can occur. This ensures that properties of the PFA compound are stable. Cooling from around 350° C. to around 35° C. may be achieved in a time of 10 to 15 minutes by the above method. The rate of cooling is a function of the cooling capacity of the water provided, the initial temperature of the press, and the size (and therefore thermal mass) of the press. Suitable modifications to the procedure can be made to achieve a particular cooling rate. For example, if a slow cooling rate is required, it may be desirable to allow the press to cool naturally. Alternatively, if an even slower cooling rate was required, the heat supplied to the press could be gradually reduced, so as to slow the cooling rate further still.

The rate of cooling has a significant effect on the properties of the PFA compound within a heating element part which is pressed according to the above described method. For example, the degree of crystallinity in the PFA compound is controlled to a large extent by the cooling speed. A rapid cooling rate causes a low degree of crystallinity, whereas a slow cooling rate causes a highly crystalline material to form. The degree of crystallinity in turn has a significant effect on the self-regulating properties of the PFA compound and consequently the heating element part. A high degree of crystallinity within the PFA compound results in a more fixed structure, and a low coefficient of thermal expansion within the material. Conversely, a low degree of crystallinity (i.e. a more amorphous structure) within the PFA compound results in a less fixed structure, and a higher coefficient of thermal expansion.

Any change in thermal expansion can be related to self-regulating behaviour. For example, a large thermal expansion coefficient for the PFA compound, resulting from a low degree of crystallinity, will result in a material with a strong self-regulation behaviour. This is because as the temperature of the material is increased, the thermal expansion in the PFA will cause the conductive filler particles to be moved further apart within the PFA matrix. By increasing the distance between adjacent conductive particles, the conductive pathways within the PFA compound are made less conductive, and the resistance of the PFA compound is increased.

On the other hand, in a more crystalline material there will be less freedom within the material for thermal expansion. For this reason, a more crystalline material will have a lower degree of thermal expansion than a less crystalline material, and consequently a less pronounced self-regulating behaviour. The PFA may for example have a crystallinity of around 60%, or some other suitable crystallinity.

Once the PFA compound is cooled, the pressing force is removed, and the mould is removed from the press. The pressed part is then removed from the mould. The pressed part will then be cooled to an ambient temperature. This part forms the electrical heater 20.

The thickness and blend of the PFA heating element 21 may be selected to deliver a particular self-regulating and/or and heat output behaviour. The proportion of conductive filler in the PFA compound may be selected to bring about a particular degree of conductivity or degree of self-regulation within the PFA heating element 21. A PFA heating element may typically comprise between 10 and 15% by weight of carbon black. For example, a blend with 15% by weight of carbon black particles will yield a highly conductive PFA element 21.

The resulting electrical heater may have self-regulating characteristics by virtue of the positive temperature coefficient of resistance (PTC) characteristic of the PFA compound.

The fabrication method described above can be readily altered to allow multiple devices to be fabricated at once in parallel using a press in conjunction with a plurality of moulds. For example a press may be arranged to accommodate four such moulds during each pressing operation.

The moulds used for each of the stages of the fabrication process described above may be sized according to the requirements of the electrical heater being made, and the specific requirements of any intended application. For example, a press having a mould of 100 mm×200 mm may be suitable for an electrical heater. The thickness of the mould voids also has an impact on the final dimensions of the electrical heater, and also in determining the power output per unit area of a particular electrical heater as discussed in more detail below.

In the above embodiment, the use of a press has been described as the mechanism by which the electrical heater is fabricated. However, it will equally be appreciated that other manufacturing methods may be used. Any technique which allows the controlled application and distribution of pressure and heat to a device may be used to manufacture an electrical heater in accordance with embodiments of the invention. For instance, other processes could be used to apply pressure and heat to obtain the desired bonding between the various components of the electrical heater, and to shape the material into the desired form.

Hot rolling is a known manufacturing technique. In hot rolling, the rollers used to process (shape) the material are used to further heat the compound being rolled. Hot rolling could be used to form an electrical heater according to embodiments of the invention. Hot rolling is a continuous process, and is thus able to produce electrical heaters having a length far in excess of those possible by pressing methods.

Alternatively, an extrusion process may be used to fabricate an electrical heater using materials described above with reference to a pressing process. For example, a fluoropolymer compound may be loaded into the hopper of an extruder, and then heated and compressed in a continuous manner, before being extruded through a die at a predetermined temperature and pressure. The die may be a sheet extrusion die. The continuous nature of the extrusion process means that idle periods are not required between processing steps, and that a separate melting phase does not need to be carried out in advance of a compression/bonding phase.

Material entering the extrusion process will gradually be compressed by a screw and heated as it approaches the die. A typical extruder screw may use a compression ratio of 3:1 along its length, compressing and heating pelletized fluoropolymer compound material. As the material reaches the die it will be molten, and have had substantially all of the air from within the material expelled by the application of force. The extruder screw may be vented to allow the escape of air or volatile species to escape.

The pressure at the die of an extruder may for example be 100 bar. A force of 200 kN applied to a pressed part with dimensions of 200 mm×100 mm, as described above is equivalent to a pressure of 100 bar, which may be observed at the die of an extruder. A pressure of as much as 650 bar may be observed at the die of an extruder. Such high pressures may be beneficial during fabrication of some parts.

In an example extrusion process, an extruded fluoropolymer heating element may be extruded at a rate of 4-5 metres per minute. Once extruded, the fluoropolymer heating element may be cooled by being passed through a cold roller.

It will be understood that extrusion may be an appropriate method for the fabrication of fluoropolymer elements for use in electrical heaters. In order to select appropriate extrusion conditions the viscosity and melt flow index of a fluoropolymer material may be taken into account. Selection of an appropriate set of extrusion conditions for a particular polymer (including fluoropolymer) material will be well known to one of ordinary skill in the art.

By using an extruder, a strip of heating element material could be formed having any desired profile, in a continuous process, yielding lengths far in excess of those possible by pressing methods. Having fabricated strips of fluoropolymer element materials by extrusion, an electrical heater can be assembled by passing a number of strips through a hot roller to bond each layer to each other layer.

Moreover, an extruded fluoropolymer heating element may be assembled into an electrical heater by being passed, while still hot, through rollers. One or more conductors (e.g. metal foil, such as aluminium foil) are provided adjacent to the extruded fluoropolymer heating element and combined with the extruded fluoropolymer heating element by the rollers. The separation of the rollers determines the thickness of a finished electrical heater. The rollers apply pressure to the outer surface of the conductors, causing the inner surface of the conductors to come into close contact with the extruded fluoropolymer heating element, and a strong bond to form between the inner surface of the conductors and the fluoropolymer heating element.

The rollers may be heated (i.e. hot rollers) to supply additional heat to the fluoropolymer heating element. This may assist with the formation of a strong bond. Alternatively, the rollers may not be heated, and the bond formed by relying on the extruded fluoropolymer heating element being molten as a result of the extrusion process (i.e. the extruded fluoropolymer heating element having remained hot between being extruded and combined with the conductors). To ensure that the extruded fluoropolymer heating element does not cool significantly between being extruded and combined with the conductors (whether the rollers are heated or not), the separation between the exit of the extrusion die and the rollers may be small. The separation may be, for example, around a few millimetres. The separation between the exit of the extrusion die and the rollers may be, for example, less than a few centimetres (e.g. less than 10 cm).

The manufacture of an electrical heater using a process in which the fluoropolymer compound is heated only once, and does not cool significantly (and thus solidify) before being bonded, may allow a stronger bond to form than a process in which a fluoropolymer compound is heated, extruded and cooled prior to being re-heated for assembly. Such a process (i.e. a process in which the fluoropolymer compound is heated only once, and does not cool significantly before being bonded) may be referred to as involving a single heating cycle. An electrical heater having been formed and assembled as described above (i.e. in a single heating cycle) may then be cooled, for example, by being passed through a cold roller (as described above), or through a water bath.

It will be appreciated that the application of a large force, for example a force of 200 kN, as described above, is an example of a force that may be used to apply a pressure to an electrical heater, in combination with a high temperature, in order to cause a strong bond to be formed between the fluoropolymer compound and the metal foil in a particular manufacturing process. Such an application of pressure, while the metal foil is in contact with the fluoropolymer compound, both expels air from within the fluoropolymer compound and from between the fluoropolymer compound and the metal foil. The pressure also forces the fluoropolymer compound to flow into any surface features of the metal foil. However, a smaller or greater pressure may be used.

The maximum pressure which may be used depends on material properties and the mechanical arrangement of the apparatus used to apply the heat and pressure. The maximum pressure may, for example, be the maximum pressure which can be applied which does not cause the molten fluoropolymer compound to be entirely forced from between the metal foils. Such a maximum pressure thus depends on several parameters such as the viscosity of the fluoropolymer compound and the geometry of the apparatus. The use of too high a pressure may cause molten fluoropolymer material to be squeezed entirely from between the metal foils such that they come into contact with one another, causing a short circuit.

The minimum pressure which may be used also depends on processing considerations, such as, for example, production speed. For example, the application of a higher pressure may increase the rate at which air is expelled from between the fluoropolymer compound and the metal foils, and may also increase the rate at which a bond is formed between the fluoropolymer compound and the metal foils. The use of a low pressure (e.g. around 1 bar), may allow an adequate bond to form, but may be considered to be uneconomic (i.e. the process will work technically, but could be too slow to be commercially viable). Therefore, 1 bar could be a minimum pressure applied during the formation of a bond between a fluoropolymer compound and a metal foil.

The pressure used may be a pressure which allows a bond to be formed in a convenient time period. In some embodiments, a small pressure (e.g. 5 bar) may be sufficient to cause a bond to be formed between the fluoropolymer heating element and the metal foils in a convenient time period. In other embodiments higher pressures (e.g. 100 bar or more, as described above) may be used.

FIG. 3 shows an electrical heater 30 which may be fabricated by a continuous method for example such as extrusion and/or rolling as described above. The electrical heater 30 comprises a stack of a fluoropolymer heating element 31, a first conductor 32, and a second conductor 33. The first and second conductors 32, 33 may be formed from a layer of metal foil. The metal foil may be any suitable metal, such as, for example aluminium foil. The parts of the electrical heater 30 may be assembled and together passed through a hot roller to form the electrical heater 30. The application of force and heat by the roller will force out any air, cause the fluoropolymer compound to partially melt, and bond the layers tightly together.

The electrical heater 30 has the shape of a ribbon, extending in a first dimension x significantly less than in a second dimension y. The thickness, in the z dimension, is less than either of the first and second dimensions. The electrical heater 30, having a thickness which is significantly less than the width or length allows the heater 30 to be flexible. The use of thin layers results in a ribbon which can be wound around an article to be heated, such as, for example a fluid carrying conduit.

In alternative embodiments, an extrusion process could be used to form a variety of continuously shaped electrical heaters.

In addition to the use of a single heating element, as illustrated in FIGS. 2 and 3, embodiments of the invention may include additional elements. For example a separate temperature regulation element may be used in addition to a fluoropolymer heating element. One such electrical heater 40 is illustrated in FIG. 4. The electrical heater 40 comprises a first conductor 41, a fluoropolymer heating element 42, a second conductor 43, a temperature regulation element 44 and a third conductor 45.

These five elements together form a stack in which each element is substantially parallel to a plane.

In use, when a voltage is applied between the outer conductors (i.e. between the first and third conductors 41, 45) a current will flow in series through the fluoropolymer heating element 42, the second conductor 43, and the temperature regulation element 44. Heat may be generated within either or both of the fluoropolymer heating element 42 and the temperature regulation element 44 by resistive heating. However, as the temperature approaches the self-regulating temperature of the temperature regulation element 44, the resistance of the temperature regulation element 44 will increase, causing the current flowing through the electrical heater 40 to be reduced.

By using an intermediate conductor (the second conductor 43) between the fluoropolymer heating element 42 and the temperature regulation element 44, it is possible to form an electrical heater 40 which has component parts from materials which would not bond well to each other, or were in some way incompatible.

In some embodiments, the use of an intermediate conductor is used between a fluoropolymer heating element and a temperature regulation element to assist with manufacturing processes. For example, a fluoropolymer heating element may adhere to the surface of a press plate during pressing. The use of a metal foil between the press plate and the fluoropolymer material prevents the sticking of the fluoropolymer to the press plate.

The temperature regulation element 44 may comprise, for example, a temperature regulation compound with a lower self-regulating temperature than is provided by the fluoropolymer heating element 42. For example, the temperature regulation compound, from which the temperature regulation element 44 is formed, may comprise a conductive filler distributed within a matrix of an electrically insulating material. The electrically insulating material may be a polymer selected from the group consisting of: high density polyethylene, medium density polyethylene, low density polyethylene, linear low density polyethylene, polypropylene, polyamides, polyester, ethylene methyl-acrylate, ethylene ethyl-acrylate, ethylene butyl-acrylate, ethylene vinyl-acetate, polyvinylidene fluoride, fluorinated ethylene propylene, ethylene tetrafluoroethylene, ethylene chlorotrifluoroethylene and polyoxymethylene.

The conductive filler may be conductive particles. The conductive particles may be particles of carbon black. Alternatively, the conductive particles may be other conductive materials such as carbon fibres, carbon nanotubes, metal powders, or a combination of different components.

The use of a fluoropolymer heating element in combination with non-fluoropolymer temperature regulation element, as illustrated in FIG. 4, allows an electrical heater to be formed having the higher power output capacity of a fluoropolymer heating element with a low self-regulation temperature of a conventional heater. For example, an electrical heater which can output over 150 W/m at temperatures below 100° C., but which also self-regulates at around 100° C. can be formed.

This combination of materials provides potentially significant power savings when compared to the use of a fluoropolymer heating element as both a heating element and a temperature regulation element in applications which do not require a self-regulation temperature of greater than about 100° C. For example, where heating is only required to a temperature of 100° C., then heating beyond 100° C. may waste a significant amount of energy. In an application where an electrical heater is intended for use to prevent freezing heating to above 100° C. will not be required.

The manufacture of the electrical heater 40 shown in FIG. 4 is similar to that of electrical heaters 20, 30 described above with reference to FIGS. 2 and 3, with the addition of processing steps to form the additional elements. For example, the electrical heater 40 may be formed by placing the electrical heater 20 in a press. A quantity of material to be used to form the temperature regulation element 44 is then added. A metal foil is then added to form the third conductor 45. The component parts are then heated and pressed, as described above. However, pressure, temperature, and pressing durations should be adapted for the specific materials properties of the material forming the temperature regulation element 43.

Care should be taken to ensure that component materials are not damaged during the pressing of subsequent elements within a multi-element electrical heater. For example, an electrical heater may comprise a temperature regulation element which comprises a polymer with a thermal degradation temperature of around 150° C. If the temperature regulation element was subjected to higher temperatures than its thermal degradation temperature during subsequent processing (i.e. pressing of a fluoropolymer heating element), then it could be damaged. However, where the melting point of a fluoropolymer compound which forms a fluoropolymer heating element is higher than the melting point of a material forming a temperature regulation element, then the further processing to form the temperature regulation element after the formation of the heating element will not adversely affect the fluoropolymer heating element.

In general, the assembly of an electrical heater comprising several elements can be carried out in stages, with each element being pressed individually before the electrical heater is assembled. For example, in an alternative manufacturing process, an electrical heater as shown in FIG. 4 can be manufactured by extrusion of each constituent layer (fluoropolymer heating element and temperature regulation element) followed by bonding of the separate layers together by the application of heat and pressure as described above (for example by rolling or pressing).

In a further alternative, co-extrusion of the two different compound materials could be used to manufacture a heater according to FIG. 4 in a single process. The use of hot and cold rollers could be used after the extrusion die (or extrusion dies) to bond the separate layers together by the application of heat and pressure as described above.

As an alternative to forming a multi-element electrical heater comprising separate heating and temperature regulation elements by using an intermediate conductor, the intermediate conductor can be omitted. FIG. 5 shows an electrical heater 50 which comprises a first conductor 51, a fluoropolymer heating element 52, a temperature regulation element 53 and a second conductor 54. These four elements together form a stack.

The electrical heater 50 shown in FIG. 5 operates and can be manufactured in a similar fashion to the electrical heater 40 shown in FIG. 4, with the omission of the intermediate conductor during manufacture, and with a bond formed directly between the fluoropolymer heating element 52 and the temperature regulation element 53. An electrical heater 50 having a fluoropolymer heating element adjacent to a non-fluoropolymer (e.g. ethylene acetate) temperature regulation element allows for a simple structure and reduced material cost when compared to a similar electrical heater having an intermediate conductor. However, such an arrangement may only be suitable for use where the materials forming the heating and temperature regulation elements are compatible with each other, and which will bond to each other.

In a further alternative embodiment, an electrical heater 60 may be formed as an offset stack, as shown in FIG. 6. The electrical heater 60 is provided with a first conductor 61, a fluoropolymer heating element 62, a temperature regulation element 63 and a second conductor 64. The first and second conductors 61, 64 are metal foils. The first conductor 61, second conductor 64 and the temperature regulation element 63 each extend in the y direction to a greater extent than in the x direction. The fluoropolymer heating element 62 extends in the x direction to a greater extent than either of the first conductor 61, second conductor 64, or the temperature regulation element 63. The first conductor 61 is disposed at a first edge of the fluoropolymer heating element 62, while the second conductor 64 and temperature regulation element 63 are disposed at a second edge of the fluoropolymer heating element 62. The first conductor 61 and combination of the second conductor 64 and the temperature regulation element 63 are spaced apart from one another so as to run parallel to each other on opposite sides and at opposite edges of the fluoropolymer heating element 62 while not overlapping. In such an arrangement, the heat output delivered by the electrical heater 60 will be determined by both the thickness of the fluoropolymer heating element 62, and also by the lateral separation, in the x-direction between the first and second conductors 61, 64.

An electrical heater according to embodiments of the invention may further comprise one or more components which have a negative temperature coefficient of resistance. For instance, in addition to a fluoropolymer element having a PTC characteristic, an NTC element may be included to act as a cold-start limiter. A cold-start limiter works by having a large resistance when an electrical heater is switched on at a cold temperature, preventing a large current surge from being drawn from the power supply. The NTC characteristic will then result in a reduction in resistance as the electrical heater heats up. When the electrical heater reaches a normal operating temperature the PTC characteristic begins to dominate, and the electrical heater will self-regulate as discussed above. PTC and NTC components may be included in series combination. Alternatively, a blended material may have both PTC and NTC characteristics. A fluoropolymer element may have both PTC and NTC characteristics.

The term temperature regulation element may be used to refer to an element, other than a heating element, having a PTC characteristic, an NTC characteristic or both PTC and NTC characteristics.

While the embodiments described above make use of carbon black as a conductive filler material, alternative conductive filler materials, as shown in Table 1 may be used instead of carbon black. However, if such alternative materials are used, then an adjustment to the proportions used may be necessary to achieve similarly performing materials to those achieved with carbon black. It will be appreciated that materials with a higher aspect ratio than spherical carbon black, such as, for example carbon fibres and carbon nanotubes, will lead to significantly different conductive pathways within the compound material. A conductive pathway within the compound material is likely to consist of alternately a portion within a conductive particle, and a portion between conductive particles where the conductive pathway bridges between adjacent conductive particles. It is these gaps which limit the conductivity of the material, and also which control the self-regulating behaviour of the material. Therefore, any change to the proportion of a conductive pathway which is made up of conductive particles rather than gaps between particles will have a significant impact on the conductivity and self-regulating behaviour of the material. The use of high aspect ratio particles of a filler material will allow a conductive pathway within a single particle to cover a significant distance, with fewer gaps required for each conductive pathway than would be required if particles with a lower aspect ratio were used.

For example, if carbon fibres were to be used instead of carbon black, then the inclusion of 5-10% by weight of the carbon fibres might provide a conductivity equivalent to the inclusion of 15% carbon black. If carbon nanotubes were included, then 2-3% by weight of nanotubes might have the same effect on conductivity as 15% carbon black. In this way, it will be seen that alterations to the composition of compound materials can be made to take advantage of the different properties of alternative materials.

A combination of different conductive fillers could be used. For example, a blend of carbon black particles and carbon nanotubes could be used as a conductive filler material in a fluoropolymer compound for use in electrical heaters. An adjustment to the proportions of each filler material may be required to take into account the difference in aspect ratio of the particular filler materials used.

One or both of a heating element or temperature regulation element (where present) may comprise a PTC element. By adjusting the material properties of component materials a temperature-resistance profile can be designed to suit a particular application. For example, the combination of several PTC elements with different PTC characteristics may allow for a more gradual reduction in the power delivered to an electrical heater as the electrical heater approaches a target self-regulating temperature. In general, where there is both a fluoropolymer heating element, and a temperature regulation element, both elements may operate to provide self-regulating behaviour. For example, the resistance of the fluoropolymer heating element may undergo a change at a first temperature, while the resistance of the temperature regulation element may undergo a change at a second temperature.

In addition to those materials described above, embodiments of the invention may further comprise thermal stabilisers. Thermal stabilisers can be added to the fluoropolymer compound, or to any polymer compound which forms part of an electrical heater. Depending on the method of compounding used, thermal stabilisers may be added in the range of approximately 1 to 15%. When there is a risk of damage to the fluoropolymer compound due to them being subjected to harsh mechanical processing conditions (e.g. shear forces, friction, temperature rises) during processing, the addition of thermal stabilisers may act to reduce or prevent any such damage.

Although some embodiments of the electrical heater have been described as comprising separate fluoropolymer elements and temperature regulation elements, the bonding process used to form the electrical heater may cause some mixing at each interface between the fluoropolymer element and temperature regulation element. As such, a well-defined boundary between the layers may not be immediately discernible on inspection of such an electrical heater, rather a gradual transition between the heating element and temperature regulation element.

In embodiments of the invention the heat output of an electrical heater is determined by the combined thickness of a fluoropolymer heating element, and any temperature regulation element (if present), and by the size of the electrical heater. Where a stack arrangement is used (e.g. FIGS. 2 to 6) the thickness of the heating element and the temperature regulation element (FIGS. 4 to 6 only) determine the heat output per unit area of the electrical heater. The total area of the electrical heater determines the overall heat output of the electrical heater, which is the product of the area and of the heat output per unit area.

While the arrangements shown in FIGS. 2 to 6 are rectangular in shape, an electrical heater may be any other shape as required for a particular application. For example, an electrical heater may be circular, square or any form of regular or irregular shape as required.

In general, electrical heaters according to embodiments of the invention have a stacked structure. This may also be regarded as a sandwich structure, the fluoropolymer heating element and the temperature regulation element being sandwiched between the first and second conductors. In some embodiments a stack may be substantially planar, each layer of the stack lying substantially parallel to a plane having a fixed separation. However, in some embodiments layers of the stack may have a separation which varies. For example, in some embodiments, layers of the stack may be mutually inclined.

In some embodiments layers of the stack may be curved. For example, an electrical heater may be considered to be substantially planar, each layer of the stack having a fixed separation. However, such an electrical heater may be applied to a curved article (e.g. a pipe) such that the layers of the stack are each arranged to follow a curved surface of the article. Such an electrical heater may still be regarded as being substantially planar, in spite of the layers not lying substantially parallel to a plane. It will be appreciated that the generally flexible nature of electrical heaters according to embodiments of the invention allows such electrical heaters to conform to a large number of shapes, as required by a desired application.

In an embodiment, the thickness of a fluoropolymer heating element may vary and may therefore deliver a different heat output to different locations. For example, an electrical heater in the form of a ribbon as shown in FIG. 3 may have a fluoropolymer heating element thickness in the z-dimension which varies along the length of the ribbon. A particular region may be required to deliver a higher heat output than another region along the ribbon, and be designed to have a different thickness. For example, a thinner region of ribbon will result in a higher current flowing through that region of the ribbon and a higher heat output being generated in that region. Conversely, a thicker region will result in a lower current flowing through that region of the ribbon and a lower heat output being generated in that region.

In a further example, an electrical heater in the form of a rectangular heater as shown in FIG. 2 may have a thickness in the z-dimension which undulates along the y-dimension. The thickness may describe a sinusoid. This example will deliver a heat output which varies across the surface of the electrical heater as a sinusoid.

In general the choice of materials used in and the dimensions of an electrical heater will determine the power output per unit area of a particular electrical heater. For example, a thicker heating element will produce a greater heat output for the same current passed through it, due to the larger resistance. However, it will require a larger voltage supplied to it to deliver the same current. A thinner fluoropolymer heating element will allow a lower voltage to be used to power the electrical heater than would be required by a similar electrical heater with a thicker fluoropolymer heating element and may be appropriate where a lower heat output is required. A further advantage of using a thin fluoropolymer heating element is that a thin heating element will be more flexible and formable than a thick heating element. Additionally, a thin heating element will require less raw materials, and therefore be less expensive to manufacture than a thick heating element. The same applies equally to the thickness of a temperature regulation element.

The thickness of each of the heating element and temperature regulation element may vary between various applications. The thickness of a heating element according to the embodiment shown in FIG. 3 may for example be greater than or equal to 0.1 mm. The thickness of a heating element according to the embodiment shown in FIG. 3 may for example be less than or equal to 20 mm. The thickness of a temperature regulation element according to embodiments of the invention may for example be greater than or equal to 0.1 mm. The thickness of a temperature regulation element according to embodiments of the invention may for example be less than or equal to 20 mm. In one example, an electrical heater may have a heating element thickness of 2 mm, and a temperature regulation element thickness of 0.5 mm. Such an electrical heater would have an overall thickness of 2.5 mm. Typically, the thickness of each of a heating element and a temperature regulation element is between 1 mm and 4 mm.

Where present, a temperature regulation element may be fabricated to be as thin as possible while maintaining a uniform thickness. It will be appreciated that any variation in material thickness will affect the resistance of that material layer. In particular, current will flow through a low resistance path in preference to a higher resistance path. As such, any uneven thickness in the heating element or temperature regulation element may result in uneven heat generation and device performance. While a thin temperature regulation element may be desirable for a particular application, for example to allow a low operating voltage to be used, a thinner layer will be affected more significantly by a small variation in thickness than a thicker layer. For example, while a layer of 10 mm would be relatively insensitive to a variation in thickness of 0.01 mm, the same variation in thickness would significantly affect the properties of a layer which was 0.1 mm in total thickness. Therefore, the minimum thickness for any particular heating element or temperature regulation element may be limited by the processes which are used to fabricate that part. Where an accurately controlled thickness can be achieved, then a thinner layer can be used. Alternatively, in an application in which precise control of the heating or regulation properties of the electrical heater are not required then a thinner layer can be safely used than would be possible in an application in which precise control of the heating or regulation properties of the electrical heater was required.

In a further embodiment of the invention, as shown in FIG. 7, an electrical heater 70 is a heating cable having a first conductor 71, a fluoropolymer heating element 72 and a second conductor 73. The heating element 72 comprises a fluoropolymer compound. The electrical heater 70 has a circular cross section, having an axis at the centre of the circular cross section. The electrical heater 70 is elongate, extending along the axis. Thus, the electrical heater 70 may be in the form of a cable. The first conductor 71 is a solid metal wire having a circular cross-section. The first conductor 71 forms the centre of the electrical heater 70, extending along the length of the electrical heater 70. The fluoropolymer heating element 72 surrounds the first conductor 71, and also extends along the length of the electrical heater 70. The second conductor 73 surrounds the fluoropolymer heating element 72 (and therefore also the first conductor 71), and also extends along the length of the electrical heater 70.

The operation of the electrical heater 70 is similar to that of the electrical heaters described with reference to previously described embodiments of the invention, for example the electrical heater of FIG. 2. In use, a voltage is applied between the first and second conductors 71, 73, causing current to flow between the conductors 71, 73 and through the fluoropolymer heating element 72, causing electrical energy to be dissipated as heat.

A continuous process (e.g. extrusion) may be used to fabricate the electrical heater 70. The electrical heater 70 may be assembled in a single extrusion process, the fluoropolymer heating element 72 and the second conductor 73 being extruded around the first conductor 71. Alternatively, in a first processing step, the fluoropolymer heating element 72 may be extruded around the first conductor 71, and in a second processing step the second conductor 73 may be extruded around the fluoropolymer heating element 72.

The application of pressure, and elevation of temperature, present at the die of an extruder provides the conditions required to achieve a good quality bond between the fluoropolymer compound and the metal conductors, forming the fluoropolymer heating element 72 and the first and second conductors 71, 73.

An extruded electrical heater may be pulled through a further reducing die (either hot or cold) in order to reduce the diameter of the heater. This additional processing step may provide an increased pressure within the heater, causing an improved bond to be formed between the ethylene acetate/acrylate compound and the metal conductors.

The geometry of the various components which form the electrical heater 70 (i.e. the first conductor 71, fluoropolymer heating element 72, and second conductor 73) define the output power and performance characteristics of the electrical heater. For example, the output power per unit length of electrical heater 70 will be set by the resistivity of the fluoropolymer heating element 72 (which may be a function of temperature), the thickness of the fluoropolymer heating element 72, and the width of the fluoropolymer heating element 72 (i.e. if the fluoropolymer heating element 72 was to be unrolled from around the first conductor 71, it could be considered to have a ‘width’). The thickness of the fluoropolymer heating element 72 may be constant (i.e. the separation between the first conductor 71 and the second conductor 72 in a radial direction). However, the area of the fluoropolymer heating element 72 which is in contact with the first conductor 71 (i.e. at the circumference of the first conductor 71) will be less than the area of the fluoropolymer heating element 72 which is in contact with the second conductor 73 (i.e. at the inner circumference of the second conductor 73). The area is the product of the ‘width’ as described above, and the length along the electrical heater 70. Therefore, the heating element may be considered to have a single effective width which is between the circumference of the first conductor 71 and the inner circumference of the second conductor 73.

Another characteristic of the electrical heater 70 which is influenced by geometry is the resistance of the conductors 71, 73. While in earlier described embodiments of the invention the use of metal foils is discussed, it will be appreciated that thicker metal layers may alternatively be used. This may be particularly appropriate in embodiments which are elongate, for example the electrical heater 30 described with reference to FIG. 3. In such embodiments, thicker metal layers may be used to reduce the resistance of the conductors. In some applications, especially where electrical heaters are required to cover large distances (e.g. oil pipelines, railway lines), voltage drop along the conductors of an electrical heater can severely limit the length of heater which can be deployed, necessitating electrical power supply connections at regular intervals. Reducing the resistance of the conductors reduces the voltage drop along their length allowing fewer electrical connections to be made. This may provide a significant advantage where providing electrical connections is expensive or inconvenient.

For example, in the electrical heater 70, the first conductor 71 may have a cross-sectional area of around 40 mm² (which corresponds to a diameter of ˜7.14 mm). The fluoropolymer heating element 72 has a thickness of 2 mm. The inner diameter of the second conductor 73 is ˜11.14 mm. The second conductor 73 has a thickness of around 1.04 mm, and therefore has a cross-sectional area of 40 mm² (i.e. the same as that of the first conductor 71). By providing large cross-section conductors, it is possible to provide an electrical heater which can be deployed in applications which require a long heater length. Large cross-section conductors can be matched (i.e. both the first and second conductors having similar large cross-sections) so as to ensure that a similar voltage drop is experienced by both conductors.

For example, when compared to a conventional heating cable having bus-wires each having a cross-sectional area of around 1.25 mm², a reduction in voltage drop along the length of an electrical heater of approximately an order of magnitude can be brought about by using conductors each having a cross sectional area of 40 mm².

An electrical heater may be designed such that the voltage drop along the length of the electrical heater is less than a predetermined amount. For example, a voltage drop of 10% of the supply voltage may be permitted along the length of a conductor within an electrical heater (i.e. a 10% voltage drop along each of the two conductors, and the remaining 80% of the voltage dropped across the heating element).

For example, a conventional heating cable having copper conductors each having a cross-sectional area of 1.25 mm², and an output power of 30 W/m when supplied with a voltage of 230 V, may extend to around 100 m in length before the voltage across the heating element at the end of the heater distant from the supply is reduced to around 80% of the supply voltage. Conversely, an electrical heater according to an embodiment of the invention having aluminium conductors each having a cross-sectional area of 40 mm², and an output power of 30 W/m when supplied with a voltage of 230 V, may extend to approximately 500 m or more in length before the voltage across the heating element at the end of the heater distant from the supply is reduced to around 80% of the supply voltage. Increasing the cross-sectional area of the conductors may thus allow the length of an electrical heater to be extended significantly.

Conductors having a cross sectional area of at least 10 mm² may be considered large cross-section conductors for the purpose of the invention. Such large cross-section conductors may provide a useful reduction in voltage drop when compared to conventional heating cables having a cross-sectional area of, for example, around 1.25 mm².

The upper limit in useful conductor cross-sectional area may be determined by factors such as material cost, cable weight, or cable flexibility. Conductors having a cross-sectional area of up to around 100 mm² may, for example, provide a useful reduction in voltage drop when compared to conventional heating cables having a cross-sectional area of, for example, around 1.25 mm², while still enabling a cost-effective and useable electrical heater. In some applications conductors with larger cross-sectional areas may be used.

It is appreciated that increasing the cross-sectional area of a conductor within a prior art heating cable would have the effect of reducing the resistance of that conductor, and therefore reducing any voltage drop along the length of that conductor. However, if large cross-section conductors were used in conventional prior art heating cables (for example, the heating cable shown in FIG. 1), this would result in the heating element having to be increased in cross-sectional area so that it would entirely surround the enlarged conductors, so as to ensure contact was maintained between the conductors and the heating element. If the heating element was not enlarged so as to entirely surround the conductors, the poor bond between the conductors and the heating element which is present in known heating cables would cause the conductors to separate from the heating element, losing electrical contact and causing poor electrical performance and reliability of the heating cable.

It will therefore be appreciated that the enhanced bonding brought about by the use of fluoropolymer compounds as a component part of electrical heaters, as described above, allows the use of large cross-section conductors in electrical heaters with a wide range of geometries.

The use of the arrangement of FIG. 7 will also ensure that the conductors cannot separate from the heating element, each layer in the device being entirely surrounded by the next layer. Further, the use of the arrangement shown in FIG. 7 allows a smaller overall cross-section to be achieved in heating cables having a given conductor cross-section when compared to conventional heating cables.

In addition to the arrangement shown in FIG. 7, it will be appreciated that large cross-section conductors can also be used in other embodiments of the invention described herein. The thickness of each conductor can be selected for a particular electrical heater taking into account the intended power output of that electrical heater and the desired length of that conductor, so as to mitigate the effect of voltage drop along the length of the conductor. For example, thick metal foils could be used in combination with the electrical heater shown in FIG. 3 to provide an electrical ribbon heater which extended in the y direction for tens or hundreds of metres without suffering from a significant voltage drop.

Similarly, it will be appreciated that additional heating elements or temperature regulation elements, for example as described with reference to FIGS. 4, 5 and 6, can be included in an electrical heater as shown in FIG. 7.

The use of an electrical heater having conductors and a fluoropolymer heating element in a circular arrangement, as shown in FIG. 7, allows the electrical heater to be bent in any direction. For example, an electrical heater as shown in FIG. 7 could be wound around a fluid carrying conduit. In such an application, it would be possible to bend the electrical heater around corners in the conduit without having to arrange the electrical heater in a particular plane in which it was able to bend. This can be understood in comparison with the substantially planar electrical heaters shown in FIGS. 2, 3, 4, 5 and 6, which, while able to bend easily in the y-z and x-z planes (depending on the thickness in the z-direction), may be difficult to bend in the x-y plane, because of their planar structure.

A disadvantage of known heating cables is the restriction to a linear cable form factor, such as that shown in FIG. 1. While this form factor is appropriate for some applications, such as for heating conduits, many applications exist where an alternative form factor may be more appropriate. The examples described above with reference to FIGS. 2 to 6 demonstrate the flexibility of the use of fluoropolymer compounds as a component part of electrical heaters.

While various embodiments of the invention have been described above, it will be appreciated that various modifications can be made to the described embodiments without departing from the spirit and scope of the present invention.

1-34. (canceled)

35. An electrical heater comprising;
a first conductor,
a second conductor,
a fluoropolymer heating element disposed between the first conductor and the second conductor, and
a temperature regulation element disposed between the fluoropolymer heating element and the second conductor;
wherein the fluoropolymer heating element comprises an electrically conductive material distributed within a fluoropolymer, and
wherein the electrical heater comprises a stack, the first conductor, the second conductor, the fluoropolymer heating element, and the temperature regulation element comprising layers of the stack.

36. An electrical heater according to claim 35, wherein the fluoropolymer is a perfluoroalkoxy copolymer.

37. An electrical heater according to claim 36, wherein the perfluoroalkoxy copolymer is a copolymer of tetrafluoroethylene and perfluoromethyl vinyl ether or of tetrafluoroethylene and perfluoropropyl vinyl ether.

38. An electrical heater according to claim 35 wherein the electrically conductive material comprises conductive particles.

39. An electrical heater according to claim 38 wherein the conductive particles are selected from carbon black, graphite, graphene, carbon fibres, carbon nanotubes, metal powders, metal strand and metal coated fibres.

40. An electrical heater according to claim 35 wherein the fluoropolymer heating element is arranged to operate as a second temperature regulation element.

41. An electrical heater according to claim 35 wherein the fluoropolymer heating element has a positive temperature coefficient of resistance.

42. An electrical heater according to claim 35 wherein the temperature regulation element comprises a second electrically conductive material distributed within an electrically insulating material.

43. An electrical heater according to claim 42 wherein the electrically insulating material comprises a polymer.

44. An electrical heater according to claim 42 wherein the second electrically conductive material comprises conductive particles.

45. An electrical heater according to claim 44 wherein the conductive particles are selected from carbon black, carbon fibres, carbon nanotubes or metal powders.

46. An electrical heater according to claim 35 wherein the thickness of the temperature regulation element is substantially constant throughout the electrical heater.

47. An electrical heater according to claim 35 wherein the electrical heater further comprises a third conductor, the third conductor being disposed between the fluoropolymer heating element and the temperature regulation element.

48. An electrical heater according to claim 47 wherein the third conductor is formed from metal foil.

49. An electrical heater according to claim 35 wherein the thickness of the fluoropolymer heating element is substantially constant throughout the electrical heater.

50. An electrical heater according to claim 35 wherein each layer of the stack lies substantially parallel to a plane.

51. An electrical heater according to claim 50 wherein the electrical heater extends in a first direction parallel to the plane to a significantly lesser extent than in a second direction parallel to the plane, the first direction being perpendicular to the second direction.

52. An electrical heater according to claim 35 wherein the first conductor and the second conductor are formed from metal foils.

53. An electrical heater according to claim 52 wherein the first conductor and/or the second conductor have a cross sectional area in a plane normal to the second direction of at least 10 mm².

54. A method of manufacturing an electrical heater, the electrical heater comprising a first conductor, a fluoropolymer compound, and a second conductor arranged in a stack, the fluoropolymer compound comprising an electrically conductive material distributed within a fluoropolymer and being disposed between the first conductor and the second conductor, wherein the first conductor is in direct contact with the fluoropolymer compound, the method comprising:
raising the temperature of the fluoropolymer compound so as to melt the fluoropolymer compound;
applying force to the first conductor and the fluoropolymer compound so as to force substantially all of the air from between the first conductor and the fluoropolymer compound and from within the fluoropolymer compound; and
cooling the fluoropolymer compound to ambient temperature such that, when cooled, the fluoropolymer compound is arranged to form a fluoropolymer heating element and is bonded to the first conductor;
wherein the method is a continuous process.

55. A method of manufacturing an electrical heater according to claim 54, the method further comprising:
providing a temperature regulation compound, the temperature regulation compound comprising a second electrically conductive material distributed within an electrically insulating material, wherein the temperature regulation compound is disposed between the second conductor and the fluoropolymer heating element, and the fluoropolymer heating element is disposed between the temperature regulation compound and the first conductor,
raising the temperature of the temperature regulation compound so as to melt the temperature regulation compound;
applying force to the first conductor, the second conductor, the fluoropolymer heating element and the temperature regulation compound so as to force substantially all of the air from between the first conductor, the second conductor, the fluoropolymer heating element and the temperature regulation compound, and from within the temperature regulation compound; and
cooling the temperature regulation compound to a temperature below the melting point of the temperature regulation compound such that, when cooled, the temperature regulation compound is arranged to form a temperature regulation element.

56. A method of manufacturing an electrical heater according to claim 55 further comprising providing a third conductor during the steps of:
raising the temperature of the fluoropolymer compound so as to melt the fluoropolymer compound; and
applying force to the first conductor, and the fluoropolymer compound so as to force substantially all of the air from between the first conductor and the fluoropolymer compound, and from within the fluoropolymer compound;
such that the fluoropolymer heating element is disposed between the first conductor and the third conductor.

57. A method of manufacturing an electrical heater, the electrical heater comprising a first conductor, a fluoropolymer compound, and a second conductor arranged in a stack, the fluoropolymer compound comprising an electrically conductive material distributed within a fluoropolymer and being disposed between the first conductor and the second conductor, wherein the first conductor is in direct contact with the fluoropolymer compound, the method comprising:
raising the temperature of the fluoropolymer compound so as to melt the fluoropolymer compound;
applying force to the first conductor, the second conductor and the fluoropolymer compound so as to force substantially all of the air from between the first conductor and the fluoropolymer compound, and from between the second conductor and the fluoropolymer compound; and
cooling the fluoropolymer compound to ambient temperature such that, when cooled, the fluoropolymer compound is arranged to form a fluoropolymer heating element and is bonded to the first conductor and the second conductor;
wherein the method is a continuous process.

58. A method of manufacturing an electrical heater according to claim 54 wherein force is at least partially applied by extrusion through a die.

59. A method of manufacturing an electrical heater according to claim 54 wherein force is at least partially applied by rollers.

60. A method of manufacturing an electrical heater according to claim 54, wherein applying force to the first conductor and the fluoropolymer compound comprises:
applying a first force to the fluoropolymer compound so as to force substantially all of the air from within the fluoropolymer compound; and
applying a second force to the first conductor and the fluoropolymer compound so as to force substantially all of the air from between the first conductor and the fluoropolymer compound.

61. A method of manufacturing an electrical heater according to claim 60 wherein the first force is applied by extrusion through a die.

62. A method of manufacturing an electrical heater according to claim 60 wherein the second first force is applied by passing the first conductor and the fluoropolymer compound through rollers.

63. A method of manufacturing an electrical heater according to claim 54, wherein the fluoropolymer is a copolymer of tetrafluoroethylene and perfluoro methyl vinyl ether or of tetrafluoroethylene and perfluoropropyl vinyl ether.

64. A method of manufacturing an electrical heater according to claim 54 wherein the electrically conductive material comprises at least one of carbon black, graphite, graphene, carbon fibres, carbon nanotubes, metal powders, metal strand and metal coated fibres.

65. An electrical heater comprising:
a first conductor which extends along a length of the electrical heater,
a fluoropolymer heating element disposed around the first conductor and along the length of the electrical heater; and
a second conductor disposed around the fluoropolymer heating element and along the length of the electrical heater;
wherein the fluoropolymer heating element comprises an electrically conductive material distributed within a fluoropolymer.

66. An electrical heater according to claim 65 wherein the first conductor and/or the second conductor have a cross sectional area in a plane normal to the length of the electrical heater of at least 10 mm².

67. An electrical heater according to claim 65, wherein the fluoropolymer is a perfluoroalkoxy copolymer.

68. An electrical heater according to claim 67, wherein the perfluoroalkoxy copolymer is a copolymer of tetrafluoroethylene and perfluoromethyl vinyl ether or of tetrafluoroethylene and perfluoropropyl vinyl ether.
